(19) United States
(12) Patent Application Publication
(10) Pub. No.: US 2023/0086581 A1
(43) Pub. Date: Mar. 23, 2023

(54) Edge Data and Replication Compliance System

(71) Applicant: BLOTOUT, INC., Fremont, CA (US)

(72) Inventors: Nejc Zdovc, Skofja Vas (SI); Mandar Shinde, Fremont, CA (US)

(21) Appl. No.: 17/948,866

(22) Filed: Sep. 20, 2022

Related U.S. Application Data
(60) Provisional application No. 63/246,196, filed on Sep. 20, 2021.

(51) Int. Cl. H04L 9/32; G06F 21/62; G06F 21/12

(52) U.S. Cl. CPC H04L 9/321; G06F 21/12; G06F 21/6263

(57) ABSTRACT

To provide user data to third-party services in a privacy compliant manner, an edge computing device within a content delivery network receives user data generated based on user interactions with web or application content from a client device proximate to the edge computing device, stores user biographical information, and performs a consent validation of the user data with respect to at least one third-party service. In response to determining that the user data passes the consent validation with respect to the third-party service, the edge computing device provides the user data to the third-party service.

This application claims priority to and the benefit of the filing date of provisional U.S. Pat. Application No. 63/246,196 entitled “Edge Data and Replication Compliance System,” filed on Sep. 20, 2021. The entire contents of the provisional application are hereby expressly incorporated herein by reference.

### FIELD OF THE DISCLOSURE

The present disclosure relates to a privacy compliant system for obtaining user data via edge computing devices in a content delivery network (CDN).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

User data has been created and utilized since the birth of the internet and its exponential growth over the past decade has created new internet users at massive scale. As Software as a Service (SaaS) services grew to service enterprises, the idea of convenience trumped the idea of how data gets stored and managed. However, when the General Data Protection Regulation (GDPR) established that data belongs to the user, the convenience of SaaS began to erode and data protection and compliance started to poke the SaaS market where it hurt. GDPR establishes principles for data that put control back to the user that creates the data when they interact with a website (also referred to herein as a “site”) or application (also referred to herein as an “app”). By establishing this core tenet back in 2018, GDPR established that any data processed by any party needs consent.

But GDPR was just the tip of the iceberg. Over the past five years, there has been significant change towards the harvesting of user data and how it gets shared globally. For example, California enacted the California Consumer Privacy Act (CCPA) and then the California Privacy Rights Act (CPRA), which does not differentiate between selling and sharing data. Additionally, China has recently cracked down on data privacy as well.

As a result of this, some browsers and applications do not allow any third-party cookies. This means that advertisers may be prevented from retargeting consumers. Additionally, some browsers and applications do not allow first-party cross domain cookies to persist for more than 7 days. This prevents third-party SaaS companies from building a footprint against a user’s behavior. Still further, some applications require explicit user permission to be tracked across other applications which has significantly damaged the retargeting ads business.

The era of privacy is upon us and it will change how SaaS companies operate. It will also bring a significant shift in how data gets collected, stored, and shared over the next decade. More critically a lot of the existing advertising and marketing media is likely to completely break and will need to be rebuilt.

Currently, many analytics and customer data platform (CDP) providers are losing anywhere from 15% to 50% of their data due to browsers and/or applications preventing third-party cookies and removing first-party cross domain cookies from persisting for more than 7 days. The era of third-party IDs and cookies is likely over. This means that ID resolution to track customer journeys will become a significant issue for companies that have thrived and relied on the easy era of convenience.

### SUMMARY

To collect and provide user data in a privacy compliant manner, edge computing devices within a content delivery network (CDN) which are proximate to respective client devices obtain, manage, and control the user data. Rather than allowing third-party services to directly communicate with browsers and applications on client device to obtain user data, an edge computing device proximate to the client device obtains the user data along with a set of permissions from the user for sharing the user data. The edge computing device performs a consent validation to determine whether the user data can be shared with each third-party service. When the edge computing device determines that the user data passes the consent validation for a particular third-party service, the edge computing device may provide the user data to the third-party service. Otherwise, the edge computing device prevents the third-party service from receiving the user data.

The consent validation may include determining whether the user has given permission to share the user data with the particular third-party service based on the set of permissions received from the client device. If the set of permissions does not include permission for the edge computing device to share the user data with the particular third-party service, the edge computing device prevents the third-party service from receiving the user data.

Additionally, the consent validation may include determining based on applicable national, state, or local laws, whether the user data can be shared with third-party services.

Still further, the edge computing device generates a user ID when a user first requests to access a website or application via a client device or browser running on the client device. The edge computing device then provides the user ID to the client device or browser. The client device or browser persistently/continuously stores the user ID, because the client device or browser recognizes the domain for the edge computing device as an authorized domain, since the domain is a first-party domain and the ID is not a cross domain ID generated from another domain. Then each time the user accesses the website or application via the client device or the browser running on the client device, the client device or browser may retrieve the stored user ID and provide the stored user ID to the edge computing device. In response to determining that the user ID passes the consent validation for a particular third-party service or the host web or application server, the edge computing device may provide the user ID to the particular third-party service or host web or application server.

In some implementations, the edge computing device generates a separate ID for each third-party service (e.g., ID-A for third-party service A, ID-B for third-party service B, etc.) or receives a separate ID from each third-party service for the same user. Then the edge computing device provides the separate ID to the respective third-party service when the user accesses the website or application. The edge computing device may also maintain a mapping of user IDs associated with the same user, so that each of the user IDs sent to the third-party services and/or the host web or application server are stored in association with the user ID stored at the client device or browser. Then when the user once again accesses the website or application via the client device or browser, the edge computing device receives the user ID from the client device or browser and obtains the respective user IDs for the particular third-party services which are mapped to the received user ID.

By collecting and managing user data at edge computing devices in a CDN, the privacy compliant system reduces network latency. More specifically, when a client device requests web content or application data from a host web or application server, the host web or application server may be hundreds or thousands of miles from the client device. This may result in a significant time delay between the time data is transmitted from the client device to the host web or application server and back to the client device. The CDN includes edge computing devices placed in several locations throughout the United States or throughout the world. In this manner, when the client device provides user data, an edge computing device is selected which is proximate to the client device (e.g., within one mile, within ten miles, within one hundred miles, etc.). The edge computing device may provide the user data to a third-party service in a significantly shorter amount of time than it would take for the host web or application server to share the user data, thereby reducing network latency.

Additionally, by collecting and managing user data at an edge computing device, the edge computing device can ensure that the user data is shared in a privacy compliant manner and prevents data loss due to new privacy regulations. This allows for a trusted domain to make decisions for how user data is handled and shared. Additionally, the edge computing device can ensure that a user’s data is deleted and not shared with a third-party service when the user opts out of sharing data with the third-party service. This is in contrast to existing data replication technologies, where the third-party service receives user data directly from a client device without any guidance from a trusted domain and there is no way to know if the third-party service actually deletes a user’s data if the user later opts out of sharing data with the third-party service.

Still further in alternative systems where third-party services collect and manage user data, a new Software Development Kit (SDK) may need to be tested and added to the website or application each time a new third-party service is added. By using the edge computing device to collect and manage the user data, new third-party services can be added seamlessly without needing to update the code for the website or application. The edge computing device may communicate with each new third-party service via an API invoked at the edge computing device without having to alter the website or application executing on the client device.

In particular, an example embodiment of the techniques of the present disclosure is a method for providing user data to third-party services in a privacy compliant manner via one or more edge computing devices in a content delivery network. The method includes receiving, at an edge computing device within a content delivery network from a client device proximate to the edge computing device, user data generated based on user interactions with web or application content provided by a host web or application server, and storing user biographical information at the edge computing device. Furthermore, the method includes performing, by the edge computing device, a consent validation of the user data with respect to at least one third-party service. In response to determining that the user data passes the consent validation with respect to the third-party service, the method includes providing, by the edge computing device, the user data to the third-party service.

Another embodiment of these techniques is an edge computing device within a content delivery network for providing user data to third-party services in a privacy compliant manner. The edge computing device includes one or more processors, and a non-transitory computer-readable memory coupled to the one or more processors and storing instructions thereon. When executed by the one or more processors, the instructions cause the one or more processors to receive, from a client device proximate to the edge computing device, user data generated based on user interactions with web or application content provided by a host web or application server, store user biographical information, and perform a consent validation of the user data with respect to at least one third-party service. In response to determining that the user data passes the consent validation with respect to the third-party service, the instructions cause the one or more processors to provide the user data to the third-party service. In some implementations, the edge computing device does not need to allocate additional processing resources to execute the steps described above. Instead, the edge computing device uses existing processing resources to process the user data.

### BRIEF DESCRIPTION OF THE DRAWINGS

FIG. 1 illustrates a schematic diagram of example components of the privacy compliant system located in dispersed geographic areas;

FIG. 2 illustrates a block diagram of an example communication system in which techniques for providing user data to third-party services can be implemented;

FIG. 3 illustrates example data being transmitted between a client device, an edge computing device, and third-party services;

FIG. 4 illustrates an example message sequence between the client device, the edge computing device, the host web or application server, and third-party services in the privacy compliant system; and

FIG. 5 illustrates a flow diagram of an exemplary method for providing user data to third-party services in a privacy compliant manner via one or more edge computing devices in a content delivery network according to certain embodiments.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘ ______’ is hereby defined to mean...” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this disclosure is referred to in this disclosure in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

As used herein, the term “user data” may refer to any suitable data related to the user. User data include user biographical information, such as the user’s name, phone number, address, email address, date of birth, etc. User data may also include demographic information, such as the user’s age, gender, etc. Furthermore, user data may include event data (also referred to herein as “user interaction data”), such as purchase items or other conversion event data including a page view event when the user views a particular web page provided by the host web or application server, a content view event when the user views a product page for a product provided by the host web or application server, an add to cart event when the user adds the product to a virtual shopping cart, an initiate checkout event when the user begins the checkout process, a purchase event when the user completes the purchase, or any other suitable event data based on user interactions with the website or application from the host web or application server executing on the client device.

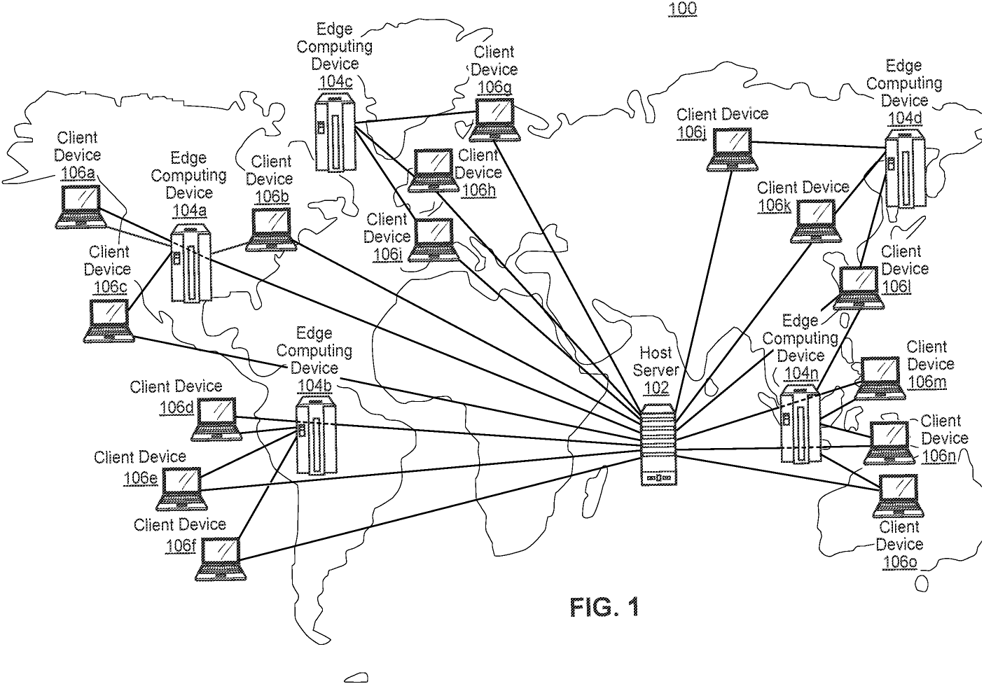

FIG. 1 illustrates the components of the privacy compliant system 100 located in dispersed geographic areas. As shown in FIG. 1, the privacy compliant system 100 may include a host web or application server 102 that stores and provides web or application content to client devices 106a-106o which may be located in several geographic regions throughout the world. The client devices 106a-106o may display the web or application content at a website via a browser or via a client application executing on the client devices 106a-106o.

Additionally, the privacy compliant system 100 includes several edge computing devices 104a-104n within a content delivery network (CDN) which act as intermediaries between the client devices 106a-106o and third-party services. The edge computing devices 104a-104n may be geographically proximate to the client devices 106a-106n (e.g., within one mile, within ten miles, within one hundred miles, etc.), and may be dispersed across several locations throughout the world. For example, the host web or application server 102 may be located in one particular geographic area or there may be a few instances of the host web or application server 102 sparsely located in different geographic regions, such as one instance of the host web or application server 102 in each continent, country, or large geographic region within a country (e.g., the eastern United States). By contrast, the CDN may include several edge computing devices 104a-104n densely located in several cities, towns, neighborhoods, etc. within a country, continent, or large geographic region.

A client device 106a-106o may receive web or application content from the host web or application server 102. Then when a client device 106a-106o generates user data, the CDN identifies the edge computing device 104a-104n closest to the client device 106-106o for example, based on the IP address of the request from the client device 106a-106o. The edge computing device 104a-104n then receives the user data from the client device 106a-106o. In this manner, the edge computing device 104a-104n can process and share the user data much faster than the host web or application server 102 due to its proximity to the client device 106a-106n, thereby reducing latency in the privacy compliant system 100.

The edge computing device 104a-104n may then forward data from the client device 106a-106o to third-party services. For example, the edge computing device 104a-104n may obtain user data from the client device 106a-106o. The user data may include user biographical information, demographic information, event data, or any other suitable data related to the user.

The edge computing device 104a-104n may then store user biographical information, and perform a consent validation for the user data with respect to one or more third-party services, as described in more detail below. Then depending on the results of the consent validation, the edge computing device 104a-104n may select third-party services to forward the user data. In this manner, the edge computing device 104a-104n acts as an intermediary between the client device 106a-106o and the third-party services.

For simplicity, FIG. 1 illustrates the host web or application server 102 as only one instance of a server. However, the host web or application server 102 according to some implementations includes a group of one or more server devices, each equipped with one or more processors and capable of operating independently of the other server devices. Server devices operating in such a group can process requests from the client device 106a-106o individually (e.g., based on availability), in a distributed manner where one operation associated with processing a request is performed on one server device while another operation associated with processing the same request is performed on another server device, or according to any other suitable technique. For the purposes of this discussion, the term “server device” may refer to an individual server device or to a group of two or more server devices. The host web or application server 102 may also be implemented in a cloud computing environment.

Additionally, while the privacy compliant system 100 includes 15 client devices and 5 edge computing devices, this is merely one example for ease of illustration only. The privacy compliant system 100 may include any suitable number of client devices and any suitable number of edge computing devices.

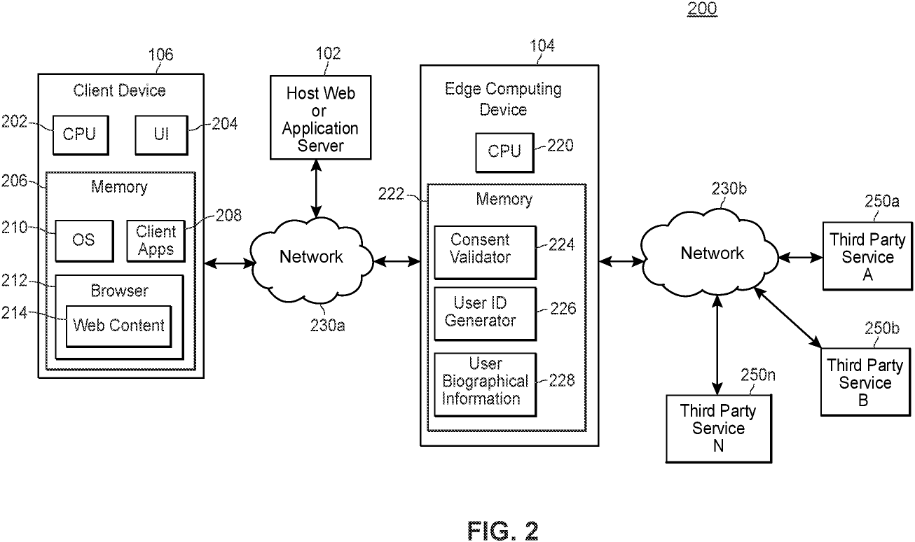

FIG. 2 illustrates a more detailed block diagram 200 of the example components 102-106, 250a-250n of the privacy compliant system 100. More specifically, the client device 106 may be a smartphone, a tablet computer, a laptop computer, a desktop computer, a wearable device such as a smart watch or smart glasses, a virtual reality headset, etc. The client device 106 may include a memory 206, one or more processors (CPUs) 204, a graphics processing unit (GPU) (not shown), an I/O module (not shown), a user interface (UI) 202, and a communication unit (not shown). The memory 206 can be a non-transitory memory and can include one or several suitable memory modules, such as random access memory (RAM), read-only memory (ROM), flash memory, other types of persistent memory, etc. The I/O module may be a touch screen, an external hardware keyboard communicating via a wired or a wireless connection (e.g., a Bluetooth keyboard), an external mouse, or any other suitable user-input device. In various implementations, the client device 106 can include fewer components than illustrated in FIG. 2 or conversely, additional components.

The memory 206 stores an operating system (OS) 210, which can be any type of suitable mobile or general-purpose operating system. The memory 210 also stores client applications 208 which may include a client application provided by the host web or application server 102. The client application 208 generally can be provided in different versions for different respective operating systems. For example, the maker of the client device 106 can provide a Software Development Kit (SDK) including the client application 208 for the Android™ platform, another SDK for the iOS™ platform, etc.

Still further, the memory 206 stores a web browser 212 that presents web content 214 for example, via a website hosted by the host web or application server 102. The web browser 212 may be implemented as a series of machine-readable instructions for receiving, interpreting, and/or displaying web page information from the host web or application server 102 while also receiving inputs from the user.

The communication unit may communicate with an edge computing device 104 selected within the CDN based on proximity to the client device 106 and/or the host web or application server 102 via any suitable wireless communication protocol network 230a, such as a wireless telephony network (e.g., GSM, CDMA, LTE, etc.), a Wi-Fi network (802.11 standards), a WiMAX network, a Bluetooth network, etc. The network 230a may be a proprietary network, a secure public Internet, a virtual private network and/or some other type of network, such as dedicated access lines, plain ordinary telephone lines, satellite links, a wireless telephony network, combinations of these, etc. Where the digital network 230a comprises the Internet, data communication may take place over the digital network 230a via an Internet communication protocol.

While the network in FIG. 2 is illustrated in two instances 230a, 230b, the network 230a, 230b may include two instances of the same network for communicating between the client device 106, the host web or application server 102, and the edge computing device 104, and for communicating between the edge computing device 104, and third-party services 250a-250n, respectively. In other scenarios, the network may include two communication networks 230a, 230b, such as a short-range communication network 230a a (e.g., a Wi-Fi network, a Bluetooth network, etc.) for communicating between the client device 104 and the edge computing device 106, and a long-range communication network 230b (e.g., a cellular network, the Internet, etc.) for communicating between the edge computing device 106 and the third-party services 250a-250n.

In some implementations, the edge computing device 104 includes one or more processors 220, a memory 222, and/or an I/O module. The memory 222 may be tangible, non-transitory memory and may include any types of suitable memory modules, including random access memory (RAM), read-only memory (ROM), flash memory, other types of persistent memory, etc. The memory 222 may store user biographical information 228 received from the client device 106. The memory also stores instructions executable on the processors 220 that make up a consent validator 224 and a user ID generator 226.

The user ID generator 226 may receive user data from the client device 106 generated when accessing a website or application provided by the host web or application server 102. When the user has accessed the website or application via the client device 106 and/or browser 212 in a previous instance, the request may include a user ID which was previously generated by the user ID generator 226. Otherwise, when the user has not previously accessed the website or application via the client device 106 and/or browser 212 or the user ID was deleted at the client device 106 and/or browser 212, the user ID generator 226 generates a new unique identifier as the user ID and provides the user ID to the client device 106 and/or browser 212.

Additionally, the user ID generator 226 may generate and store an ID graph mapping the user ID generated at the edge computing device 104 to user IDs used by third-party services 250a-250n. For example, each third-party service 250a-250n may generate a different user ID corresponding to the user ID generated by the edge computing device 104. The user ID generator 226 may store a mapping of the user ID generated by the edge computing device 104 (e.g., ID-S) to each ID for the same user generated by the third-party services 250a-250n (e.g., ID-A for third-party service A, ID-B for third-party service B, etc.). The edge computing device 104 may also store user biographical information with the user ID. Then when the edge computing device 104 and more specifically, the consent validator 224 determines that user data can be provided to a particular third-party service 250a-250n, the user ID generator 226 obtains the user ID and corresponding user biographical information from the stored mapping for the particular third-party service (e.g., ID-A for third-party service A).

The consent validator 224 may provide an indication to the client device 106 to present one or more prompts for obtaining permissions from the user to share user data. In some implementations, the prompt may be a general prompt for the requesting whether the user gives permission to share user data. In other implementations, the client device 106 may present a series of prompts requesting whether the user gives permission to share data with each third-party service 250a-250n or the client device 106 may present the series of prompts for specific third-party services after receiving a response to the general prompt indicating that the user gives consent to share data. For example, the third-party services 250a-250n may be advertising, marketing, and/or analytics services, such as Facebook™ Ads, TikTok™ Ads, Snapchat™ Ads, Attentive®, Segment, etc.

The client device 106 may present a first prompt requesting whether the user gives permission to share data with third-party service A 250a, a second prompt requesting whether the user gives permission to share data with third-party service B 250b, an nth prompt requesting whether the user gives permission to share data with third-party service N 250n, etc. In yet other implementations, the client device 106 may present a single prompt with user controls, such as checkboxes for selecting whether the user gives permission to share data with each third-party service 250a-250n.

Additionally, the prompts may include requests for obtaining permissions to share specific types of user data with each third-party service 250a-250n. For example, the client device 106 may present a first prompt requesting whether the user gives permission to share event data, and a second prompt requesting whether the user gives permission to share demographic data.

In some implementations, the consent validator 224 may provide an indication to the client device 106 to present the one or more prompts each time the user accesses the website or application so that the user can opt out of sharing data after previously giving permission to share user data. In any event, the client device 106 may receive responses to the one or more prompts from the user and may provide one or more permissions to the edge computing device 104, and more specifically, the consent validator 224. For example, the permissions may include permission to share user data, permission to share user data with third-party service A 250a, permission to share user data with third-party service B 250b, permission to share user data with third-party service N 250n, permission to share demographic data, permission to share event data, permission to share demographic data with third-party service A 250a, permission to share event data with third-party service A 250a, etc. The permissions may also indicate third-party services 250a-250n that the user does not give permission to share user data with, may indicate specific types of user data that the user does not give permission to share, or may indicate that the user does not give permission to share user data at all. The consent validator 224 may then determine whether the user data can be provided with each third-party service 250a-250n based on the permissions. If the permissions indicate that the user does not give permission to share user data at all, the consent validator 224 may provide an indication to the third-party services 250a-250n that the user having the user ID or the specific user ID for each third-party service 250a-250n has opted out of sharing user data along with a request to each of the third-party services 250a-250n to remove the user data for the user.

Additionally, the consent validator 224 may obtain location information for the client device 106, such as an IP address. The consent validator 224 may then determine the location of the client device 106 based on the location information. The consent validator 224 may also identify a set of state compliance requirements for a geographic area that includes the location. For example, the edge computing device 104 may store sets of state compliance requirements for different jurisdictions/geographic areas, such as a first set of state compliance requirements for Europe corresponding to the GDPR, a second set of state compliance requirements for California corresponding to the CCPA/CPRA, a third set of state compliance requirements for China, etc. In any event, the consent validator 224 identifies the set of state compliance requirements corresponding to the location of the client device 106 and applies the set of state compliance requirements to the user data.

In this manner, the privacy compliant system 100 allows for an automated application of privacy law via user consent without providing user data which has not passed the consent validation to the third-party services 250a-250n. Accordingly, the privacy compliant system 100 enables a privacy compliance structure with little or no code required by the host enterprise to manage the user data. The privacy compliant system 100 may be a zero code system that automatically helps the host enterprise stay compliant with local laws without writing any code and includes audit logs.

The consent validator 224 may then share the user data based on the results of the consent validation. For example, if the consent validator 224 determines that the user data can be shared with a particular third-party service 250a-250n based on the permissions provided by the user and/or the set of state compliance requirements for the user’s location, the edge computing device 104 may provide the user data and/or the user ID to the particular third-party service 250a-250n via the network 230b. Otherwise, the consent validator 224 prevents the particular third-party service 250a-250n from receiving the user data, thereby preventing the persistent storage of the user data when the permissions and/or the set of state compliance requirements for the user’s location do not allow it.

In yet another example, if the consent validator 224 determines that a particular type of user data (e.g., event data) can be shared with a particular third-party service 250a-250n, the edge computing device 104 may provide the particular type of user data and/or the user ID to the particular third-party service 250a-250n via the network 230b without providing other types of user data to the particular third-party service 250a-250n. The edge computing device 104 may provide the user data and/or the user ID to a particular third-party service 250a-250n by invoking an application programming interface (API) for the particular third-party service 250a-250n, such as a Conversion API (e.g., Facebook™ Conversion API).

In some implementations, the entire functionality of the consent validator 224 can be performed on the client device 106 in addition to the edge computing device 104. For example, the client device 106 may perform the consent validation and the edge computing device 104 may also perform the consent validation for two levels of validation to reduce the likelihood that user data incorrectly passes the consent validation. Then if either device 104, 106 determines that the user data does not pass the consent validation for a particular third-party service 250a-250n, the edge computing device 104 prevents the particular third-party service 250a-250n from receiving the user data. In another example, some portions of the consent validation may be performed on the client device 106 while other portions are performed on the edge computing device 104.

In this manner, the edge computing device 104 acts as a trusted storage environment where only the edge computing device 104 has access to user data that can be altered to meet compliance requirements before replicating the user data in a persistent storage or at a third-party service. Additionally, by storing the user biographical information and performing computations at the edge computing device 104, the privacy compliant system 100 secures the user data at the edge computing device 104 and can determine how to enable safe and private data replication at the edge computing device 104 based on global privacy policies. The edge computing device 104 processes the user data “on the fly” as it is transmitted from the client device 106 before the user data is stored persistently or shared with third party services 250a-250n.

While the privacy compliant system 100 as shown in FIG. 2 includes 3 third-party services, this is merely one example for ease of illustration only. The privacy compliant system 100 may include any suitable number of third-party services.

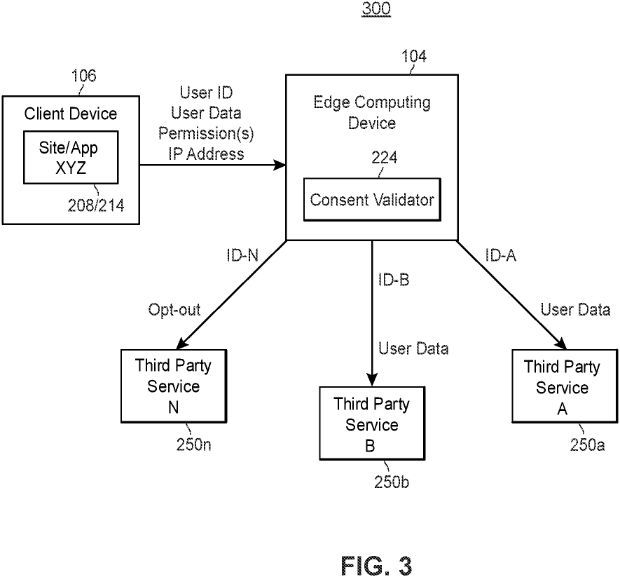

FIG. 3 illustrates an example scenario 300 where user data is transmitted between the client device 106, the edge computing device 104, and the third-party services 250a-250n. For example, the client device 106 and/or the browser 212 may transmit (i) the user ID generated by the edge computing device 104 and stored at the client device 106 and/or the browser 212, (ii) user data generated by the user, (iii) the set of permissions by the user for sharing the user data, and/or (iv) location information for the client device 106 (e.g., an IP address) to the edge computing device 104. The consent validator 224 then performs a consent validation by identifying a set of state compliance requirements for the user’s location, applying the set of state compliance requirements to the user data, and analyzing the set of permissions with respect to each third-party service 250a-250n.

In the example scenario 300, the consent validator 224 determines that the user gives permission to share user data with third-party services A and B 250a, 250b but the user opts out of sharing user data with third-party service N 250n. Accordingly, the edge computing device 104 determines based on the ID mapping, the specific user IDs for the third-party services A and B 250a, 250b which are mapped to the user ID. The edge computing device 104 then provides ID-A and the user data to third-party service A 250a, and ID-B and the user data to third-party service B 250b. The edge computing device 104 also provides an indication to third-party service N 250n that the user corresponding to ID-N opted out of sharing user data. In other implementations, the edge computing device 104 does not provide information to third-party service N 250n indicating that the user corresponding to ID-N opted out of sharing user data and instead merely stops sharing user data with third-party service N 250n. The edge computing device 104 may also generate an audit log indicating that the user opted out of sharing user data with third-party service N 250n. Moreover, the edge computing device 104 may store the user ID along with user biographical information, and the mapping of the user ID to each of the specific user IDs for the third-party services 250a-250n.

In this manner, if the user later opts out of sharing user data altogether, the edge computing device 104 ensures that user data is not shared with any of the third-party services 250a-250n to protect the privacy of the user.

By managing and controlling the user data at the edge computing device 104, the edge computing device 104 can easily integrate a new third-party service into the privacy compliant system 100. For example, rather than having to download a new SDK for the new third-party service at the client device 106 and/or the browser 212, the edge computing device 104 may generate and provide new prompts to the client device 106 for requesting permission to share user data with the new third-party service. In response to determining that the user data can be shared with the new third-party service, the edge computing device 104 invokes a new API for providing the user ID and/or the user data to the new third-party service without having to add additional code for receiving and processing the user data with respect to the new third-party service. This results in an easy and efficient process for adding or removing third-party services to the privacy compliant system 100 and does not require the user to install updates at the client device 106.

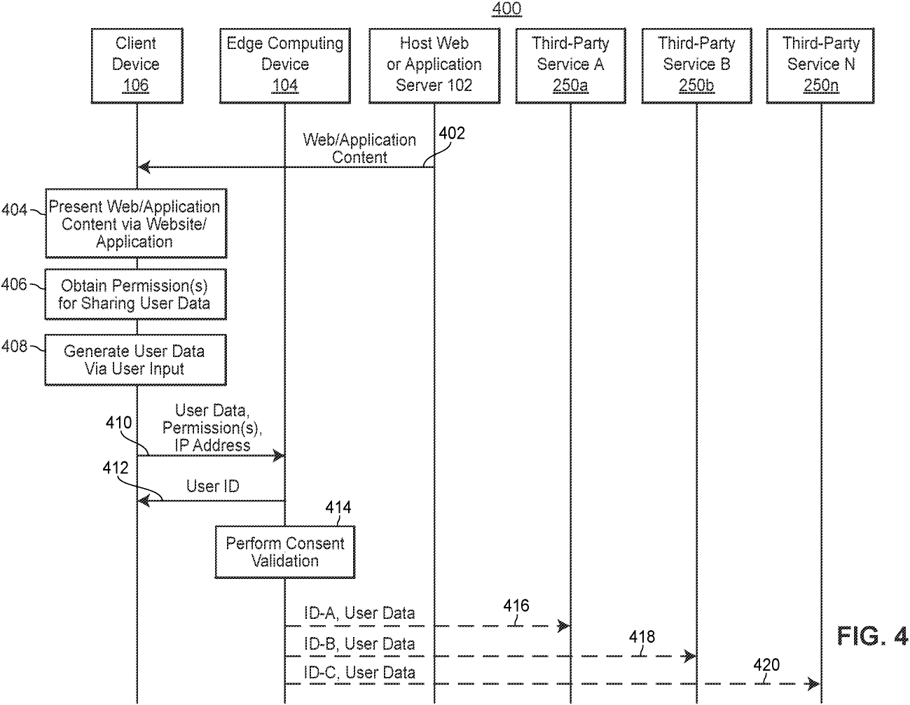

FIG. 4 illustrates an example message sequence 400 between the client device 106, the edge computing device 104, the host web or application server 102, and third-party services 250a-250n. The host web or application server 102 may provide 402 web or application content for the website or client application to the client device 106 in response to a request from the client device 106 for web content or application data for a website or client application provided by the host web or application server 102.

The client device 106 then presents 404 the web content or application data via the website or application provided by the host web or application server 102. The edge computing device 104 may provide an indication to the client device 106 to present one or more prompts for obtaining permissions from the user to share user data. The client device 106 presents the prompts and obtains 406 permissions for sharing the user data by receiving selections of user controls by the user responding to the prompts. For example, a first prompt may ask the user whether the user gives permission to share user data, and the user may select a first user control indicating that the user gives permission to share user data. A second prompt may ask which third-party services the user gives permission to share user data with and which types of user data can be shared with each third-party service. The second prompt may include several user controls, such as checkboxes for selecting the third-party services and/or the types of user data to share with each third-party service.

The client device 106 may also generate 408 user data via user input. For example, the user may enter their name, email address, phone number, etc. at the website or client application. The user may also create event data at the website or client application by selecting various products, adding the products to a virtual shopping cart, and/or purchasing the products.

The client device 106 may then send 410 the user data, set of permissions, and/or location information (e.g., an IP address) to the edge computing device 104. In some implementations, the set of permissions is sent separately from the user data. For example, the client device 106 may send an IP address and a set of permissions in a first transmission to the edge computing device 104. Then at a later time, the client device 106 may send user biographical information to the edge computing device 104 in a second transmission. In a third transmission, the client device 106 may send event data to the edge computing device 104, such as an add to cart event.

The edge computing device 104 may analyze the set of permissions and state compliance requirements for a geographic area corresponding to the user’s location to perform 414 a consent validation for the user data with respect to each third-party service 250a-250n. The edge computing device 104 may also determine whether the client device 106 transmitted a user ID with the user data. If the client device 106 did not transmit a user ID, the edge computing device 104 generates a new user ID and provides 412 the new user ID to the client device 106. The client device 106 then stores the user ID in association with the website or application, for example as a cookie. As mentioned above, because the user ID is from an authorized domain generated at the edge computing device 104, since the domain is a first-party domain and the user ID is not a cross domain ID generated from another domain and is not generated at the client device 106 and/or browser 212, the client device 106 and/or the browser 212 persistently stores the user ID in association with the website or application.

Then based on the results of the consent validation, the edge computing device 104 may determine whether to send the user data and which types of user data to send to third-party service A 250a, third-party service B 250b, and third-party service N 250n.

For example, in response to determining that the user data passes the consent validation with respect to third-party service A 250a, the edge computing device 104 may transmit 416 the specific user ID for third-party service A 250a (e.g., ID-A) and/or the user data to third-party service A 250a. Otherwise, the edge computing device 104 prevents the user data and/or the user ID from being provided to third-party service A 250a.

In another example, in response to determining that the user data passes the consent validation with respect to third-party service B 250b, the edge computing device 104 may transmit 418 the specific user ID for third-party service B 250b (e.g., ID-B) and/or the user data to third-party service B 250b. Otherwise, the edge computing device 104 prevents the user data and/or the user ID from being provided to third-party service B 250b.

In yet another example, in response to determining that the user data passes the consent validation with respect to third-party service N 250n, the edge computing device 104 may transmit 420 the specific user ID for third-party service N 250n (e.g., ID-N) and/or the user data to third-party service N 250n. Otherwise, the edge computing device 104 prevents the user data and/or the user ID from being provided to third-party service N 250n.

In an example scenario, the client device 106 obtains permissions for sharing user data by receiving selections of user controls by the user responding to prompts asking the user whether the user gives permission to share user data, which third-party services the user gives permission to share user data with, which types of user data can be shared with each third-party service, etc. The client device 106 transmits the permissions to the edge computing device 104. Then the edge computing device 104 generates a new user ID and provides the new user ID to the client device 106. The client device 106 then obtains user biographical information at the website or client application for the user, such as a name, email address, phone number, etc., which is also provided to the edge computing device 104 with the user ID for the user. Then the edge computing device 104 stores the user biographical information with the user ID.

Then when the user generates event data at the client device 106 by interacting with the website or client application provided by the host web or application server 102, the client device 106 transmits the event data with the user ID to the edge computing device 104. The edge computing device 104 performs the consent validation for the user data. In response to determining that the user data passes the consent validation with respect to a particular third-party service, the edge computing device 104 obtains the user biographical information stored with the user ID and appends the event data to the user ID and user biographical information for the user. Then the edge computing device 104 provides the user ID, user biographical information, and event data to the particular third-party service.

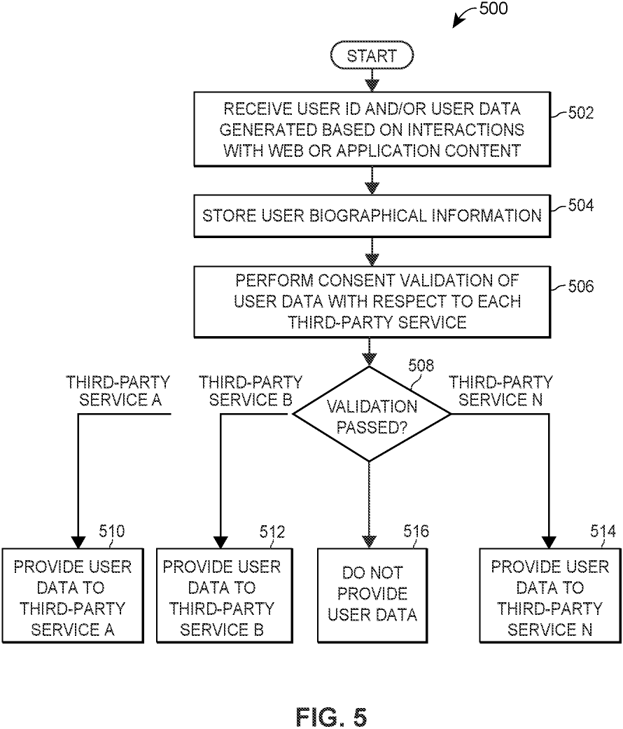

FIG. 5 illustrates an example method 500 for providing user data to third-party services in a privacy compliant manner, which can be implemented in an edge computing device 104. The method can be implemented in a set of instructions stored on a computer-readable memory and executable at one or more processors of the edge computing device 104.

The client device 106 presents web content or application data via a website or application provided by the host web or application server 102. The edge computing device 104 may also provide an indication to the client device 106 to present one or more prompts for obtaining permissions from the user to share user data. The client device 106 presents the prompts and obtains permissions for sharing the user data by receiving selections of user controls by the user responding to the prompts.

The client device 106 may also generate user data based on user interactions with the website or client application. For example, the user may enter their name, email address, phone number, etc. at the website or client application. The user may also create event data at the website or client application by selecting various products, adding the products to a virtual shopping cart, and/or purchasing the products.

At block 502, the edge computing device 104 receives user data that was generated based on user interactions with the web or application content. In some implementations, the edge computing device 104 also receives a set of permissions for sharing the user data from the client device 106 and/or location information from the client device 106. Also in some implementations, the edge computing device 104 receives a user ID from the client device 106. If the edge computing device 104 does not receive a user ID with the user data, the edge computing device 104 generates a new user ID and provides the new user ID to the client device 106. The client device 106 then persistently stores the user ID in association with the website or client application, for example as a cookie for more than the 7 day period allowed for first-party cross domain cookies. Otherwise, if the edge computing device 104 includes a user ID, the edge computing device 104 does not generate a new user ID.

The edge computing device 104 stores user biographical information (block 504), and performs a consent validation of the user data with respect to each third-party service in a set of predetermined third-party services 250a-250n (block 506).

More specifically, for each third-party service in the set, the edge computing device 104 determines whether and which types of user data can be provided to the third-party service based on the received set of permissions from the user and/or an identified set of state compliance requirements for a geographic area corresponding to the user’s location.

If the edge computing device 104 determines that the user data passes the consent validation for third-party service A 250a, the edge computing device 104 provides the user data to third-party service A 250a (block 510). The edge computing device 104 may also provide the user ID to third-party service A 250a or a specific user ID for third-party service A 250a (e.g., ID-A) mapped to the user ID in a stored mapping at the edge computing device 104. In some implementations, the edge computing device 104 may determine that a particular type of user data passes the consent validation for third-party service A 250a (e.g., event data). The edge computing device 104 may then provide the particular type of user data to third-party service A 250a without providing other types of user data to third-party service A 250a.

Otherwise, if the edge computing device 104 determines that the user data does not pass the consent validation for third-party service A 250a, the edge computing device 104 prevents the user ID and/or the user data from being provided to third-party service A 250a. If the user previously shared user data with third-party service A 250a but now has elected to opt out of sharing user data with third-party service A 250a, the edge computing device 104 may provide an indication to third-party service A 250a that the user having the user ID or the specific user ID for third-party service A 250a has opted out of sharing user data.

If the edge computing device 104 determines that the user data passes the consent validation for third-party service B 250b, the edge computing device 104 provides the user data to third-party service B 250b (block 512). The edge computing device 104 may also provide the user ID to third-party service B 250b or a specific user ID for third-party service B 250b (e.g., ID-B) mapped to the user ID in a stored mapping at the edge computing device 104. In some implementations, the edge computing device 104 may determine that a particular type of user data passes the consent validation for third-party service B 250b (e.g., demographic data). The edge computing device 104 may then provide the particular type of user data to third-party service B 250b without providing other types of user data to third-party service B 250b.

Otherwise, if the edge computing device 104 determines that the user data does not pass the consent validation for third-party service B 250b, the edge computing device 104 prevents the user ID and/or the user data from being provided to third-party service B 250b. If the user previously shared user data with third-party service B 250b but now has elected to opt out of sharing user data with third-party service B 250b, the edge computing device 104 may provide an indication to third-party service B 250b that the user having the user ID or the specific user ID for third-party service B 250b has opted out of sharing user data.

If the edge computing device 104 determines that the user data passes the consent validation for third-party service N 250n, the edge computing device 104 provides the user data to third-party service N 250n (block 514). The edge computing device 104 may also provide the user ID to third-party service N 250n or a specific user ID for third-party service N 250n (e.g., ID-N) mapped to the user ID in a stored mapping at the edge computing device 104. In some implementations, the edge computing device 104 may determine that a particular type of user data passes the consent validation for third-party service N 250n (e.g., demographic data). The edge computing device 104 may then provide the particular type of user data to third-party service N 250n without providing other types of user data to third-party service N 250n.

Otherwise, if the edge computing device 104 determines that the user data does not pass the consent validation for third-party service N 250n, the edge computing device 104 prevents the user ID and/or the user data from being provided to third-party service N 250n. If the user previously shared user data with third-party service N 250n but now has elected to opt out of sharing user data with third-party service N 250n, the edge computing device 104 may provide an indication to third-party service N 250n that the user having the user ID or the specific user ID for third-party service N 250n has opted out of sharing user data.

If the edge computing device 104 determines that the user data does not pass the consent validation for any third-party services, the edge computing device 104 does not provide the user data to any of the third-party services (block 516).

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for providing privacy compliant user data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for providing user data to third-party services in a privacy compliant manner via one or more edge computing devices in a content delivery network, the method comprising:
receiving, at an edge computing device within a content delivery network from a client device proximate to the edge computing device, user data generated based on user interactions with web or application content provided by a host web or application server;
storing user biographical information at the edge computing device;
performing, by the edge computing device, a consent validation of the user data with respect to at least one third-party service; and
in response to determining that the user data passes the consent validation with respect to the third-party service, providing, by the edge computing device, the user data to the third-party service.

2. The method of claim 1, wherein performing a consent validation of the user data includes:
obtaining location information for the client device;
applying state compliance requirements to the user data based on the location information; and
determining whether the user data can be provided to the third-party service based on the state compliance requirements.

3. The method of claim 1, wherein performing a consent validation of the user data includes:
obtaining one or more permissions from the client device; and
determining whether the user data can be provided to the third-party service based on the one or more permissions obtained from the client device.

4. The method of claim 3, wherein at least one of the permissions indicates third-party services permitted to receive the user data.

5. The method of claim 1, further comprising:
generating, by the edge computing device, a user identifier for a user;
providing, by the edge computing device, the user identifier to the client device, wherein the user identifier is stored at the client device; and
receiving, at the edge computing device, the user identifier with the user data.

6. The method of claim 5, wherein the client device determines that the user identifier is from an authorized domain, such that the user identifier is a persistent user identifier that the client device continuously stores in response to determining that the persistent user identifier is from the authorized domain, and wherein the client device provides the persistent user identifier to the edge computing device each time the client devices accesses a website or application provided by the host web or application server.

7. The method of claim 5, further comprising:
providing, by the edge computing device, the user identifier to the third-party service.

8. The method of claim 5, further comprising:
obtaining, at the edge computing device from the third-party service, a specific user identifier for the third-party service;
storing, by the edge computing device, a mapping of the user identifier to the specific user identifier for the third-party service; and
in response to determining that the user data passes the consent validation with respect to the third-party service, providing, by the edge computing device, the specific user identifier to the third-party service.

9. The method of claim 1, wherein the user data passes the consent validation in a first instance, and further comprising:
in a second instance:
in response to determining that the user data does not pass the consent validation with respect to the third-party service, preventing, by the edge computing device, the user data from being provided to the third-party service.

10. The method of claim 1, further comprising:
receiving, by the edge computing device, a request to add a new third-party service;
in response to receiving the request, performing the consent validation of the user data with respect to the new third-party service; and
in response to determining that the user data passes the consent validation with respect to the new third-party service, providing, by the edge computing device, the user data to the new third-party service.

11. An edge computing device within a content delivery network for providing user data to third-party services in a privacy compliant manner, the edge computing device comprising:
one or more processors; and
a non-transitory computer-readable memory coupled to the one or more processors and storing instructions thereon that, when executed by the one or more processors, cause the one or more processors to:
receive, from a client device proximate to the edge computing device, user data generated based on user interactions with web or application content provided by a host web or application server;
store user biographical information;
perform a consent validation of the user data with respect to at least one third-party service; and
in response to determining that the user data passes the consent validation with respect to the third-party service, provide the user data to the third-party service.

12. The edge computing device of claim 11, wherein to perform a consent validation of the user data, the instructions cause the edge computing device to:
obtain location information for the client device;
apply state compliance requirements to the user data based on the location information; and
determine whether the user data can be provided to the third-party service based on the state compliance requirements.

13. The edge computing device of claim 11, wherein to perform a consent validation of the user data, the instructions cause the edge computing device to:
obtain one or more permissions from the client device; and
determine whether the user data can be provided to the third-party service based on the one or more permissions obtained from the client device.

14. The edge computing device of claim 13, wherein at least one of the permissions indicates third-party services permitted to receive the user data.

15. The edge computing device of claim 11, wherein the instructions further cause the edge computing device to:
generate a user identifier for a user;
provide the user identifier to the client device, wherein the user identifier is stored at the client device; and
receive the user identifier with the user data.

16. The edge computing device of claim 15, wherein the client device determines that the user identifier is from an authorized domain, such that the user identifier is a persistent user identifier that the client device continuously stores in response to determining that the persistent user identifier is from the authorized domain, and wherein the client device provides the persistent user identifier to the edge computing device each time the client devices accesses a website or application provided by the host web or application server.

17. The edge computing device of claim 15, wherein the instructions further cause the edge computing device to:
provide the user identifier to the third-party service.

18. The edge computing device of claim 15, wherein the instructions further cause the edge computing device to:
obtain, from the third-party service, a specific user identifier for the third-party service;
store a mapping of the user identifier to the specific user identifier for the third-party service; and
in response to determining that the user data passes the consent validation with respect to the third-party service, provide the specific user identifier to the third-party service.

19. The edge computing device of claim 16, wherein the user data passes the consent validation in a first instance, and the instructions further cause the edge computing device to:
in a second instance:
in response to determining that the user data does not pass the consent validation with respect to the third-party service, prevent the user data from being provided to the third-party service.

20. The edge computing device of claim 11, wherein the instructions further cause the edge computing device to:
receive a request to add a new third-party service;
in response to receiving the request, perform the consent validation of the user data with respect to the new third-party service; and
provide the user data to the new third-party service in response to determining that the user data passes the consent validation with respect to the new third-party service.
